(19) United States
(12) Patent Application Publication
(10) Pub. No.: US 2023/0290564 A1
(43) Pub. Date: Sep. 14, 2023

(54) WINDING ARRANGEMENT, TRANSFORMER AND METHOD FOR PRODUCING A WINDING ARRANGEMENT

(71) Applicant: HITACHI ENERGY SWITZERLAND AG, Baden (CH)

(72) Inventors: Gianluca Bustreo, Mirano (VE) (IT); Paolo Pavanello, Granze (PD) (IT); Massimo Carmignoto, Montegrotto Terme (PD) (IT); Roger Eklund, Ludvika (SE); Orlando Girlanda, Västerås (SE)

(21) Appl. No.: 18/018,152

(22) PCT Filed: Jul. 14, 2021
(86) PCT No.: PCT/EP2021/069570

§ 371 Date: Jan. 26, 2023

(30) Foreign Application Priority Data
Aug. 11, 2020 (EP) 20190466.1

(51) Int. Cl. H01F 27/32; H01F 27/30

(52) U.S. Cl. CPC H01F 27/327; H01F 27/303

(57) ABSTRACT

A winding arrangement for a transformer includes a plurality of stabilising elements, a winding block, a top end press element and a bottom end press element. The top end press element is arranged on a top end of the winding block and the bottom end press element is arranged on a bottom end of the winding block. The plurality of stabilising elements are arranged to make the winding arrangement self-supporting and isolated from short circuit forces, wherein the at least one stabilising element comprises any one out of: at least one insulated tie-rod made of fibre glass or plastic, arranged between the top end press element and the bottom end press element and at least one insulated band arranged around the winding block, the top end press element and the bottom end press element.

### CROSS REFERENCE TO RELATED APPLICATIONS

This application is a 35 U.S.C. § 371 national stage application of PCT International Application No. PCT/EP2021/069570 filed on Jul. 14, 2021, which in turn claims priority to European Patent Application No. 20190466.1, filed on Aug. 11, 2020, the disclosures and content of which are incorporated by reference herein in their entireties.

### TECHNICAL FIELD

The present disclosure relates to the field of power transformers. In particular, the present disclosure relates to a winding arrangement for a transformer configured for withstanding short-circuit forces.

### BACKGROUND

A power transformer is equipment used in an electric grid of a power system. Power transformers transform voltage and current in order to transport and distribute electric energy.

FIG. 1 illustrates a schematic overview of a winding structure 10 for a transformer according to the state of the art. A winding block 11, comprising one or more windings, of a transformer is supported by the winding structure 10 that links the windings to a core 14 of the transformer. The winding structure 10 also comprises a press ring top 12 and a press ring bottom 13. The press ring top 12 is arranged on a top end of the winding block 11 and the press ring bottom 13 is arranged on a bottom end of the winding block 11. The winding structure 10 further comprises support 17, 18 and press blocks 15, 16 located at the top end and bottom end of the winding block 11.

Short-circuit withstand capability is an important issue for transformers, e.g., power transformers. When a short circuit occurs, the currents through the windings normally attain values one order of magnitude higher than the rated ones, and therefore the forces rise accordingly. Normally these forces are dynamically transmitted to various parts of the transformer such as to a winding conductor, winding support and press blocks, e.g., yoke clamps. During production, the windings are individually dried, pressed, height adjusted and delivered to an active assembly line part. At an assembly area, the core is equipped with the windings one by one. With all windings assembled on the core and after stacking/mounting the top end press block, the windings are pressed down to the final height and locked under mounting force by placing High Density Laminated Pressboard (HDLP) shims under the winding support and press blocks. HDLP shims are flat rectangular pieces of laminated pressboard. A mass of the winding block is partly transferred to bottom end clamps and partly to a bottom yoke. The winding clamping force is partly transferred to the top and bottom core clamps and partly to the yokes.

The present disclosure presents an improved viable solution of a winding arrangement that is self-supporting and isolated from short circuit forces.

### SUMMARY

It is an object of embodiments herein to enhance short-circuit withstand capability for a winding arrangement, or at least to achieve an alternative to known solutions within the technical field.

According to an aspect the object is achieved by providing a winding arrangement for a transformer. The winding arrangement comprises at least one stabilising element, a winding block, a top end press element and a bottom end press element. The top end press element is arranged on a top end of the winding block and the bottom end press element is arranged on a bottom end of the winding block. The at least one stabilising element is arranged to make the winding arrangement self-supporting and isolated from short circuit forces. The at least one stabilising element comprises any one out of: at least one insulated tie-rod made of fibre glass or plastic, arranged between the top end press element and the bottom end press element and at least one insulated band arranged around the winding block, the top end press element and the bottom end press element.

According to another aspect the above mentioned object is also achieved by providing a method for producing a winding arrangement. The winding arrangement comprises at least one stabilising element, a winding block, a top end press element and a bottom end press element. The top end press element is arranged on the top end of the winding block and the bottom end press element is arranged on the bottom end of the winding block. The at least one stabilising element comprises any one out of: at least one insulated tie-rod made of fibre glass or plastic, arranged between the top end press element and the bottom end press element and at least one insulated band arranged around the winding block, the top end press element and the bottom end press element. The winding arrangement presses the winding block together by applying an assembly force from the top end press element to the winding block. The winding arrangement further arranges the winding block to a predetermined height by use of the assembly force. The winding arrangement further arranges the at least one stabilising element between the top end press element and the bottom end press element. The winding arrangement further locks the at least one stabilising element. The winding arrangement then further releases the assembly force to the winding block when the winding block has reached a predetermined height, thereby making the winding arrangement self-supporting and isolated from short circuit forces.

It is furthermore provided herein a transformer comprising an embodiment of the winding arrangement of the present disclosure.

### BRIEF DESCRIPTION OF THE FIGURES

Further technical features of the present disclosure will become apparent through the following description of one or several exemplary embodiments given with reference to the appended figures, where:

FIG. 1 is a schematic overview depicting a winding arrangement for a transformer according to prior-art;

FIG. 2 is a schematic overview depicting an exemplifying winding arrangement for a transformer, according to some embodiments herein;

FIG. 3 is a schematic overview depicting tie rods as stabilising elements, according to some embodiments herein;

FIG. 4A is a schematic overview depicting bands as stabilising elements, according to some embodiments herein;

FIG. 4B is another schematic overview depicting bands as stabilising elements, according to some embodiments herein;

FIG. 5 is a schematic overview depicting internal cylinders as stabilising elements, according to some embodiments herein;

FIG. 6 is a schematic overview depicting external cylinders as stabilising elements, according to some embodiments herein; and

FIG. 7 is a flow chart showing a method for producing a winding arrangement, according to some embodiments herein.

It should be noted that the drawings have not necessarily been drawn to scale and that the dimensions of certain elements may have been exaggerated for the sake of clarity.

### DETAILED DESCRIPTION

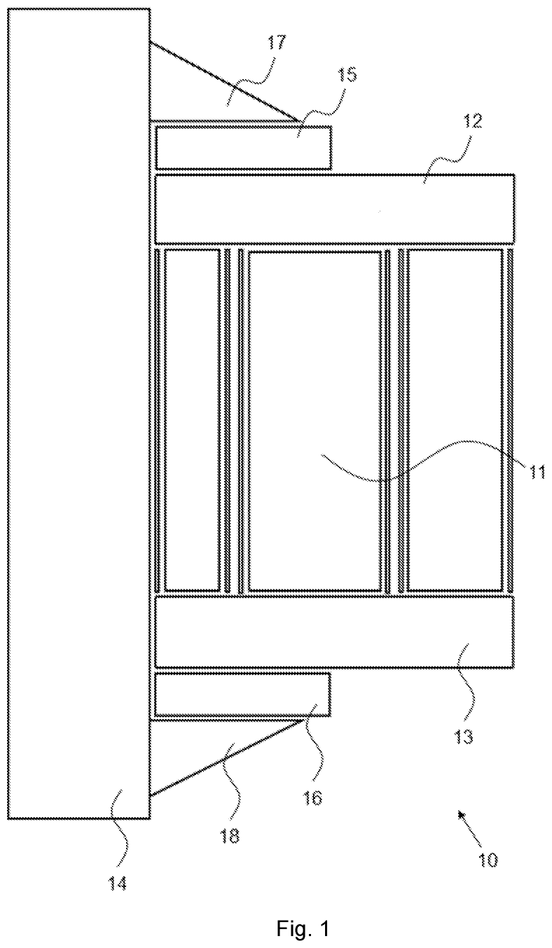

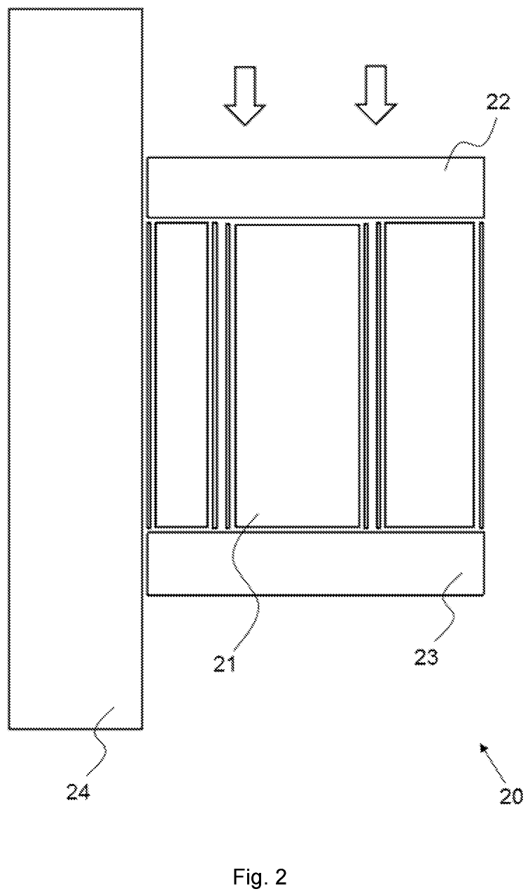

FIG. 2 illustrates a winding arrangement 20 for a transformer according to embodiments herein. The winding arrangement 20 comprises at least one winding block 21, a top end press element 22 and a bottom end press element 23. The winding block 21 comprises one or more windings. FIG. 2 also shows a core 24 of the transformer. The top end press element 22 is arranged on a top end of the winding block 21 and the bottom end press element 23 is arranged on a bottom end of the winding block 21. As further described in detail in conjunction with the below figures, the winding arrangement 20 includes at least one stabilising element that is arranged to make the winding arrangement 20 self-supporting and isolated from short circuit forces. The stabilising element(s) provide isolation for the winding arrangement 20 so to reduce or eliminate the transfer of forces to e.g., yoke clamps, while enabling the winding arrangement 20 to maintain sufficient rigidity. Thus, by simplifying the winding arrangement 20, elements such as support 17, 18 and press blocks 15, 16 (shown in FIG. 1) may be removed.

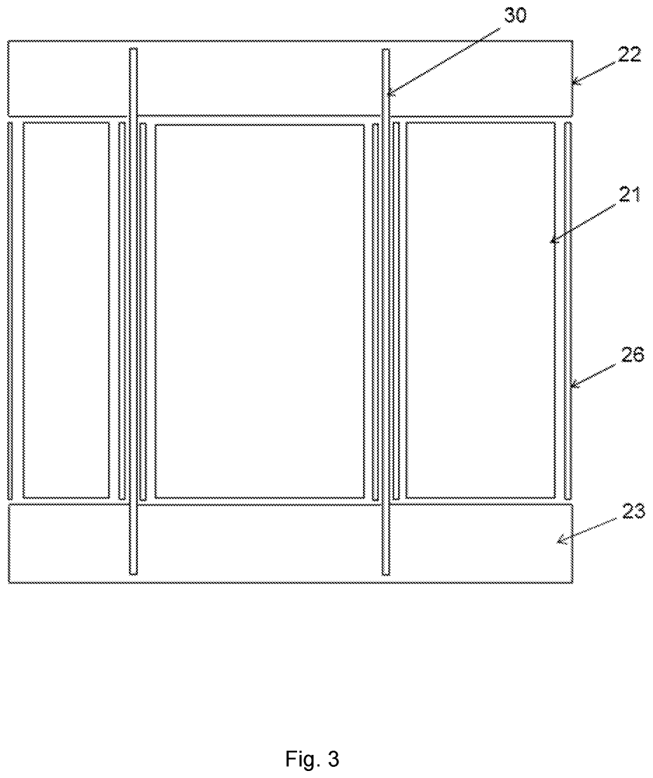

FIG. 3 illustrates a schematic overview according to some embodiments, wherein the at least one stabilizing element may comprise at least one insulated tie-rod 30. As shown in FIG. 3, the winding arrangement 20 may comprise the winding block 21, the top end press element 22, the bottom end press element 23 and the at least one insulated tie-rod 30. The winding arrangement 20 may further comprise one or more barriers 26. The at least one insulated tie-rod 30 may be arranged between the top end press element 22 and the bottom end press element 23. The at least one tie-rod 30 may be arranged internally between the top end press element 22 and the bottom end press element 23. The at least one tie-rod 30 may be made of e.g., fibre glass or plastic. The barrier 26 may be used for dielectric purposes. Using one or more tie-rods 30 is advantageous because the tie-rods 30 are located in the same radial space used for cooling or for dielectric reasons, so it fulfils its function without requiring additional space.

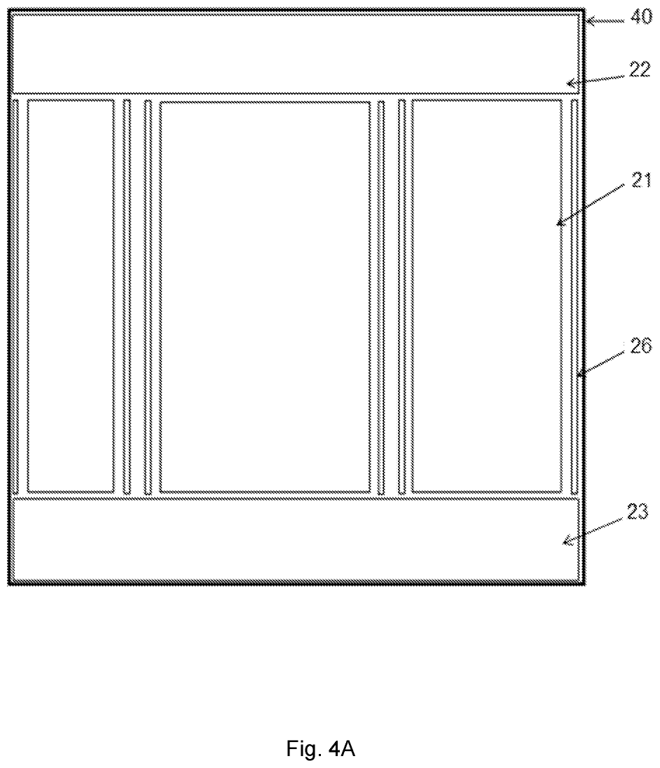

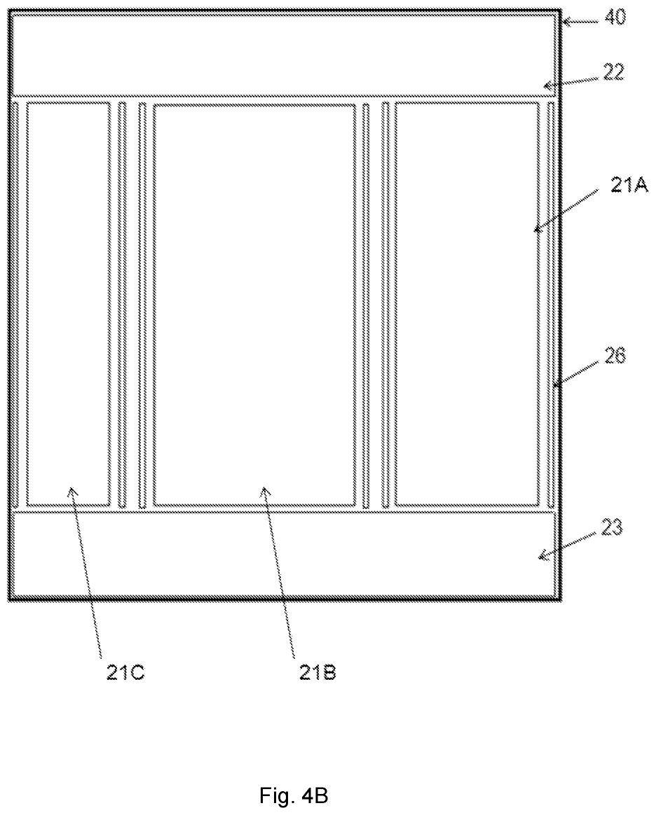

FIG. 4A illustrates a schematic overview according to some embodiments, wherein the at least one stabilizing element may comprise at least one insulated band 40. In FIG. 4a the winding arrangement 20 may comprise the winding block 21, the top end press element 22, the bottom end press element 23, the at least one insulated band 40 and the barrier 26. The at least one insulated band 40 may be arranged around the winding block 21, the top end press element 22 and the bottom end press element 23. The at least one band 40 may be made of e.g., fibre glass or plastic. Using at least one insulated band 40 is advantageous because the press elements 22 and 23 can be of any suitable thickness as the at least one band 40 is not required to be fixed on them. Alternatively, the at least one insulated band 40 may be arranged around one or more of the individual winding blocks, shown as 21A, 21B and 21C in FIG. 4B.

According to some embodiments the at least one stabilizing element may comprise at least one cylinder 50. The at least one cylinder 50 may be insulated. The at least one cylinder 50 may be arranged between the top end press element 22 and the bottom end press element 23. The at least one cylinder 50 may be made of e.g., pressboard or plastic. This embodiment of using at least one cylinder 50 is advantageous because it is using one of the already existing components within the winding block 21 to achieve an additional function.

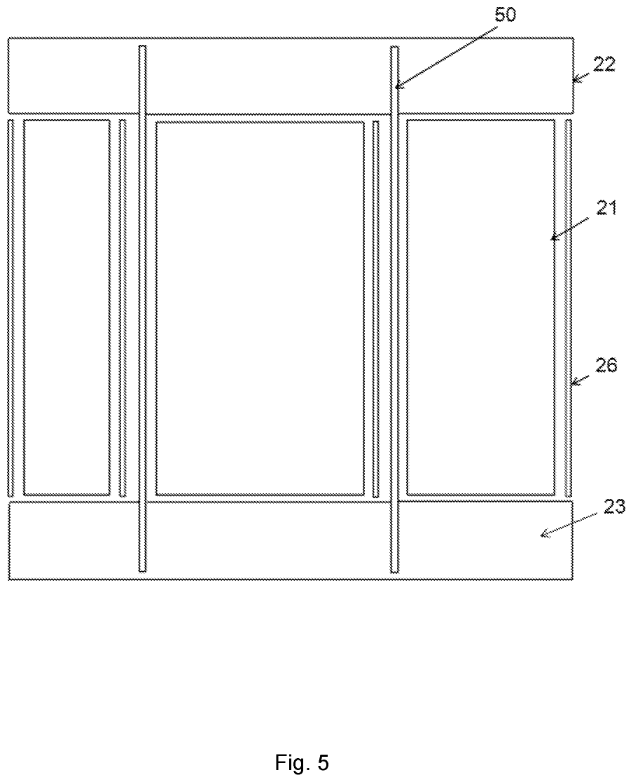

FIG. 5 illustrates a schematic overview according to some embodiments, wherein the at least one cylinder may be arranged internally. In FIG. 5 the winding arrangement 20 may comprise the winding block 21, the top end press element 22, the bottom end press element 23, the at least one internally arranged cylinder and the barrier 26.

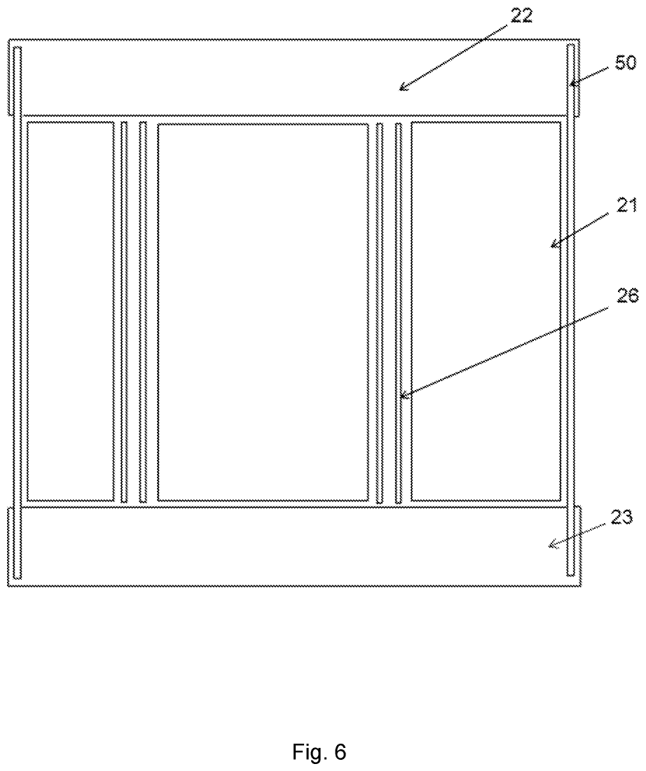

FIG. 6 illustrates a schematic overview according to some embodiments, wherein the at least one cylinder may be arranged externally. In FIG. 6 the winding arrangement 20 may comprise the winding block 21, the top end press element 22, the bottom end press element 23, the at least one externally, e.g., outer, arranged cylinder and the barrier 26. The at least one cylinder 50 may thus be arranged internally as per FIG. 5 or externally as per FIG. 6. The selection may depend on the opportunity of the specific case.

According to some embodiments, the at least one cylinder 50 may be arranged both internally and externally between the top end press element 22 and the bottom end press element 23. This is advantageous because one of the already existing components within the winding block 21 to achieve an additional function is used.

According to some embodiments the at least one stabilizing element may be assembled with the winding block 21 to compress, e.g., clamp, the winding block 21.

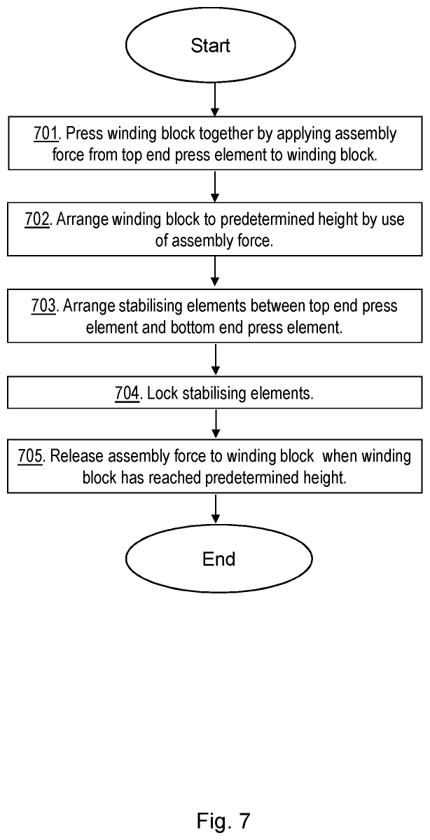

A method for producing the winding arrangement 20 according to some embodiments herein may be employed in terms of actions as illustrated by the flow chart in FIG. 7. Some optional example embodiments that could be used in this procedure will also be described. The winding arrangement 20 comprises the at least one stabilising element, the winding block 21, the top end press element 22 and the bottom end press element 23. The top end press element 22 is arranged on the top end of the winding block 21 and the bottom end press element 23 is arranged on the bottom end of the winding block 21.

Action 701 comprises pressing the winding block 21 together by applying an assembly force from the top end press element 22 to the winding block 21.

Action 702 comprises arranging the winding block 21 to a predetermined height by use of the assembly force.

Action 703 comprises arranging the at least one stabilising element between the top end press element 22 and the bottom end press element 23.

Action 704 comprises locking, e.g., fastening, the at least one stabilising element.

Action 705 comprises releasing the assembly force to the winding block 21 when the winding block 21 has reached a predetermined height.

In the above-described method for producing the winding arrangement 20 according to embodiments herein, the windings are individually dried, pressed, height adjusted and then assembled together as one block. In the winding press the winding block 21 is pressed down to a final height and locked with the stabilizing elements. An advantage with this solution is that the windings for each limb will be delivered to the active part line as one component with the windings already under press.

According to some embodiments, the at least one stabilising element may comprise at least one insulated tie-rod 30 arranged between the top end press element 22 and the bottom end press element 23. This may enable to fix and compress the windings with the use of the press elements 22, 23. This solution may permit a continued regulation of the height of the winding and a simple adjustment during the transforming manufacturing, according with appropriate design constraints.

According to some embodiments, the at least one stabilising element may comprise at least one insulated band 40. The insulated band 40 may be arranged around the winding block 21, the top end press element 22 and the bottom end press element 23. This may enable to fix and compress the windings with the use of the press elements 22, 23.

According to some embodiments, the at least one stabilising element may comprise at least one cylinder 50 arranged between the top end press element 22 and the bottom end press element 23. The at least one cylinder 50 may be insulated.

According to some embodiments, the at least one cylinder 50 may be arranged internally between the top end press element 22 and the bottom end press element 23. The at least one cylinder 50 may thus be fixed to the press elements 22, 23 during the winding manufacturing, e.g., the drying and compressive phase. This solution is advantageous because already known material may be used in the winding manufacturing, without introducing any new type of material which may require a compatibility study, e.g., of oil, temperature, dielectric compatibility, but only a mechanical withstand investigation. This in turn reduces costs.

According to some embodiments, the at least one cylinder 50 may be arranged externally between the top end press element 22 and the bottom end press element 23.

The at least one cylinder 50 may according to some embodiments be arranged both internally and externally between the top end press element 22 and the bottom end press element 23.

The current solution is based on the realisation that by adapting the actual winding sticks a self-supporting structure can be created that is able to maintain the size of the winding and withstanding short circuit forces. Thus, by pressing the winding block together by applying an assembly force, arranging the winding block to a predetermined height by use of the assembly force, arranging the at least one stabilising element between the top end press element and the bottom end press element, locking the stabilising elements and releasing the assembly force when the winding block has reached a predetermined height the winding arrangement is made self-supporting and isolated from short circuit forces. In turn the short circuit withstand capability for the winding arrangement is enhanced.

An advantage with embodiments herein is thus to maintain the size of the winding arrangement and to withstand the short circuit forces by keeping pressure on individual windings without the need of structures external to the winding block assembly. Another advantage of embodiments herein is that the winding block can be installed in each core column in a single process step. Another advantage of embodiments herein that the winding block height is maintained constant throughout the manufacturing process.

Consequently, a winding arrangement that is self-supporting and isolated from short circuit forces and a method for producing the winding arrangement is achieved.

It is to be noted that any feature of any of the aspects may be applied to any other aspect, wherever appropriate. Likewise, any advantage of any of the aspects may apply to any of the other aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

It will be appreciated that the foregoing description and the accompanying drawings represent non-limiting examples of the method and winding arrangement taught herein. As such, the winding arrangement and techniques taught herein are not limited by the foregoing description and accompanying drawings. Instead, the embodiments herein are limited only by the following claims and their legal equivalents.

1. A winding arrangement for a transformer, wherein the winding arrangement comprises:
at least one stabilizing element;
a winding block; and
a top end press element and a bottom end press element;
wherein the top end press element is arranged on a top end of the winding block and the bottom end press element is arranged on a bottom end of the winding block, and wherein the at least one stabilizing element is arranged to make the winding arrangement self-supporting and isolated from short circuit forces, wherein the at least one stabilizing element comprises any one out of: at least one insulated tie-rod made of fiberglass or plastic, arranged between the top end press element and the bottom end press element and at least one insulated band arranged around the winding block, the top end press element and the bottom end press element.

2. The winding arrangement according to claim 1, wherein at least one stabilizing element is assembled with the winding block to compress the winding block.

3. A transformer comprising the winding arrangement according to claim 1.

4. A method for producing a winding arrangement, wherein the winding arrangement comprises at least one stabilizing element, a winding block, a top end press element and a bottom end press element, and wherein the top end press element is arranged on the top end of the winding block and the bottom end press element is arranged on the bottom end of the winding block, wherein the at least one stabilizing element comprises any one out of: at least one insulated tie-rod made of fiberglass or plastic, arranged between the top end press element and the bottom end press element and at least one insulated band arranged around the winding block, the top end press element and the bottom end press element, the method comprising:
pressing the winding block together by applying an assembly force from the top end press element to the winding block;
arranging the winding block to a predetermined height by use of the assembly force;
arranging the at least one stabilizing element between the top end press element and the bottom end press element;
locking the at least one stabilizing element; and
releasing the assembly force to the winding block when the winding block has reached a predetermined height, thereby making the winding arrangement self-supporting and isolated from short circuit forces.

5. The method according to claim 4, wherein the winding block comprises windings, the method further comprising:
individually drying the windings;
pressing the windings; and
assembling the windings together as the winding block.

6. The method according to claim 4, wherein the at least one stabilizing element comprises at least one insulated tie-rod made of fiberglass or plastic.

7. The method according to claim 6, wherein the at least one insulated tie rod is arranged between the top end press element and the bottom end press element.

8. The method according to claim 4, wherein the at least one stabilizing element comprises at least one insulated band.

9. The method according to claim 8, wherein the at least one insulated band is arranged around the winding block, the top end press element and the bottom end press element.

10. The method according to claim 4, wherein the at least one stabilizing element comprises at least one cylinder.

11. The method according to claim 10, wherein the at least one cylinder is internally arranged or externally arranged between the top end press element and the bottom end press element.

12. The method according to claim 4, further comprising locking the winding block with the at least one stabilizing element.

13. The transformer according to claim 3 wherein at least one stabilizing element is assembled with the winding block to compress the winding block.

14. The winding arrangement according to claim 1, wherein the winding block comprises one or more windings.

15. The winding arrangement according to claim 14, wherein the winding arrangement further comprises a barrier around each of the one or more windings.

16. A winding arrangement for a transformer, wherein the winding arrangement comprises:
a winding block;
a top end press element arranged on a top end of the winding block;
a bottom end press element arranged on a bottom end of the winding block; and
a stabilizing element connected to the top end press element and the bottom end press element, wherein the stabilizing element is arranged to make the winding arrangement self-supporting and isolated from short circuit forces;
wherein the stabilizing element comprises:
an insulated tie-rod made of fiberglass or plastic, arranged between the top end press element and the bottom end press element, or
an insulated band arranged around the winding block, the top end press element and the bottom end press element.

17. The winding arrangement according to claim 16, wherein the winding block comprises one or more windings.

18. The winding arrangement according to claim 17, wherein the winding arrangement further comprises a barrier around each of the one or more windings.

19. The winding arrangement according to claim 16, wherein the winding block is locked with the stabilizing element.

20. The winding arrangement according to claim 16, wherein the stabilizing element is assembled with the winding block to compress the winding block.
